(19) United States
(12) Patent Application Publication
(10) Pub. No.: US 2016/0110661 A1
(43) Pub. Date: Apr. 21, 2016

(54) System and Method for Forecasting of Asset Marketing

(71) Applicant: IgnitionOne,Inc., New York, NY (US)

(72) Inventors: Caroline B. McConnell, Atlanta, GA (US); John M. Turner, Roswell, GA (US); Murray M. Webb, II, Atlanta, GA (US)

(21) Appl. No.: 14/887,600

(22) Filed: Oct. 20, 2015

Related U.S. Application Data
(60) Provisional application No. 62/066,007, filed on Oct. 20, 2014.

(51) Int. Cl. G06Q 10/06; G06Q 30/02

(52) U.S. Cl. CPC G06Q 10/067; G06Q 30/0202

(57) ABSTRACT

A marketing asset forecasting system for determining the spend budget for marketing assets based upon marketing budgets. The present invention can be configured to optimize marketing budgets based upon budget limitations, forecasted revenue, and other limitations. The present invention is configured to forecast revenue across a multiple of marketing assets based upon marketing budgets taking into account seasonality.

### CLAIM OF PRIORITY

This application claims priority from U.S. Provisional Patent Application No. 62/066,007, filed Oct. 20, 2014, which is relied upon and incorporated herein in its entirety by reference.

### BACKGROUND OF THE INVENTION

1. Technical Field

The present invention is in the technical field of marketing forecasting. More particularly, the present invention is in the technical field of media mix modeling, and more specifically referring to digital media ad spending as it relates to spending across digital media assets.

2. Related Art

As more environments, including digital environments, are becoming more complex, individuals are turning towards various forms of technology for assistance. The same is true for the digital marketing environment. There are different marketing assets that comprise the digital marketing environment. The assets can include specific advertising campaigns, advertisement groups, creative types (e.g., paid search ads, display ads, etc.), client accounts (i.e., the grouping of all the data of a client, including all of the related assets (creative, campaigns, groups, spend, revenue, etc.)), audiences, and marketing channels.

For example, marketing channels can include, but are not limited to, paid search, display, organic search, paid social, organic social, and referring URLS. Paid search can be broken down into different marketing tactics to reach consumers at different points during the marketing funnel. Paid search non-brand can be used by an advertiser when trying to generate brand awareness about a product or service. A paid brand search can focus on looking at a particular brand (e.g., Extended Stay Hotels). Display advertising includes advertisements that appear on a website. Display advertising can be generally divided into two types: remarketing and prospecting. Prospecting occurs when an advertiser is trying to reach a potential client that has not previously expressed interest in their brand or product. Remarketing occurs when a potential consumer has visited a website of an advertiser or selected (i.e., clicked on) on an advertisement previously so the advertiser wants to remarket the consumer. Other types of marketing channels include, but are not limited to, TV, e-mail, mobile and point of sale.

Marketing personnel are routinely tasked to create marketing budgets across such respective assets. Marketing personnel face several challenges in creating these budgets. The marketing budgets can be based upon projected return of investment (ROI) and cost of service (COS). Generally speaking, the projected ROI and COS must be generated based upon past managed and non-managed performance, cost, and total of sales or transactions.

Further, the data associated with this type of research generally falls into one of the following classifications: email, search, display, mobile, and social media. In the past, marketing personnel could focus their research on one specific media type in order to generate the marketing budget for that specific channel or asset (e.g., campaigns, accounts, device types, etc.). However, as these assets and digital channels have begun to be integrated, marketing personnel have been called upon to incorporate the broad range of media types into a single overall marketing plan. As integrated media has evolved into a combination of all of the above, the research task has evolved as well. Marketing personnel must take into account every marketing based insight that the current environment allows. Due to this evolved media landscape, the task of optimally deciding how to allocate a marketing budget across assets, including channels, has increased in complexity. Individuals must now be able to determine marketing budgets for each marketing channel while also taking into account the marketing budgets for the other channels as well, as well as many other marketing requirements imposed upon them. Other requirements can include campaign promotions, seasonality of their products and goods, upcoming product releases, market conditions, and competing information. Current systems available fail to provide marketing personnel with tools sufficient to do such budgeting. Likewise, systems employed today fail to show the holistic impact for each marketing channel in combination with others. Further, many systems used to determine marketing budgets fail to provide a means for identifying the impact of seasonality on marketing budgets and corresponding revenue.

Therefore, there is a need for a system and method to determine marketing budgets across multiple marketing channels and assets. There is also a need for a marketing forecasting system and method that provides marketing personnel with a way to optimize budgets based upon budget limitations and requirements. Further, there is a need for a system that can take into account seasonality in developing such budgets across multiple marketing channels and assets.

### SUMMARY OF INVENTION

The present invention is a system and method for forecasting revenue across a multiple of marketing assets based upon marketing budgets. In an aspect, the present invention can be configured to optimize marketing budgets based upon budget limitations, forecasted revenue, and other limitations. In an exemplary aspect, the present invention is configured to forecast revenue across a multiple of marketing assets based upon marketing budgets. In an aspect, the present invention is configured to optimize marketing budgets taking into account seasonality. In an aspect, the present invention is configured to convey the relationship of the revenue projections attributable to each marketing asset in a holistic manner. In another aspect, the present invention can be configured to optimize against a number of transactions or assets (specific campaigns, specific device types, creative, etc.) based upon the same limitations.

In an aspect, the system is configured to be separate from all forms of automatic advertising, allowing the system to be able to incorporate information from past and current marketing decisions on an ongoing basis.

These and other objects and advantages of the invention will become apparent from the following detailed description of the preferred embodiment of the invention.

Both the foregoing general description and the following detailed description are exemplary and explanatory only and are intended to provide further explanation of the invention as claimed. The accompanying drawings are included to provide a further understanding of the invention and are incorporated in and constitute part of this specification, illustrate several embodiments of the invention, and together with the description serve to explain the principles of the invention.

### BRIEF DESCRIPTION OF THE DRAWINGS

FIG. 1 is a schematic representation of a marketing asset forecasting system according to an aspect.

FIG. 2 is a flow chart of a process performed by the marketing asset forecasting system according to an aspect.

FIG. 3 is a block diagram of the marketing asset forecasting application of FIG. 1 according to an aspect.

FIG. 4 is a flow chart of a process performed by the marketing asset forecasting system according to an aspect.

FIG. 5 is a flow chart of a process performed by the marketing asset forecasting system according to an aspect.

FIG. 6 is a flow chart of a process performed by the marketing asset forecasting system according to an aspect.

FIG. 7 is a flow chart of a process performed by the marketing asset forecasting system according to an aspect.

FIG. 8 illustrates a GUI generated by the marketing asset forecasting system according to an aspect.

FIG. 9 illustrates a chart generated by the marketing asset forecasting system according to an aspect.

FIG. 10 illustrates a chart generated by the marketing asset forecasting system according to an aspect.

FIG. 11 illustrates a chart generated by the marketing asset forecasting system according to an aspect.

FIG. 12 illustrates a GUI generated by the marketing asset forecasting system according to an aspect.

### DETAILED DESCRIPTION OF THE EMBODIMENTS

The present invention will now be described more fully hereinafter with reference to the accompanying drawings, which are intended to be read in conjunction with this detailed description, the summary, and any preferred and/or particular embodiments specifically discussed or otherwise disclosed. This invention may, however, be embodied in many different forms and should not be construed as limited to the embodiments set forth herein. Instead, these embodiments are provided by way of illustration only and so that this disclosure will be thorough, complete and will fully convey the full scope of the invention to those skilled in the art.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc., of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. In addition, the present methods and systems may be implemented by centrally located servers, remote located servers, or cloud services. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, computers and components found in cloud services, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The methods and systems that have been introduced above, and discussed in further detail below, have been and will be described as comprised of units. One skilled in the art will appreciate that this is a functional description and that the respective functions can be performed by software, hardware, or a combination of software and hardware. A unit can be software, hardware, or a combination of software and hardware. In one exemplary aspect, the units can comprise a computer. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, cloud services, mobile devices (e.g., smart phones, tablets, and the like) and multiprocessor systems. Additional examples comprise set top boxes, programmable consumer electronics, network PCs, minicomputers, mainframe computers, enterprise servers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc., that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

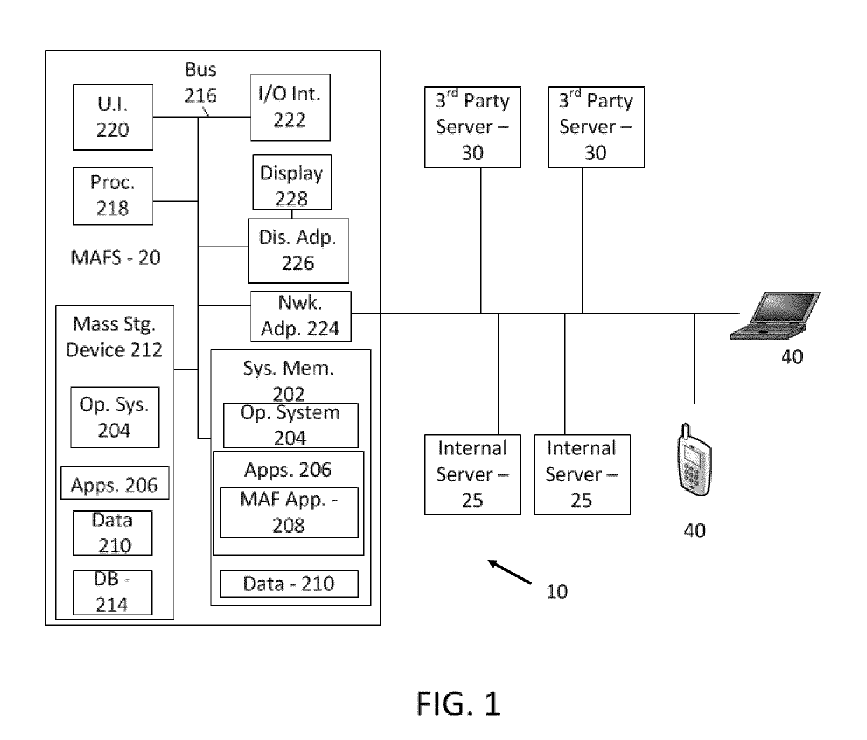

FIG. 1 illustrates a marketing asset forecasting system 10 according to an aspect of the present invention. As shown in FIG. 1, the marketing asset forecasting system 10 includes a marketing asset forecasting server (MAFS) 20 configured to communicate with internal servers 25 and third party servers 30. In an aspect, the marketing asset forecasting server 20 can be configured to forecast revenue and budgets across multiple marketing assets to generate the greatest amount of revenue possible, discussed in more detail below. In an exemplary aspect, the marketing asset forecasting server 20 can be configured to forecast across multiple marketing channels.

The marketing asset forecasting server 20 can be configured to communicate with internal servers 25 and third party servers 30 configured to pass along data. In an aspect, the data can include data that is tracked from online advertisements, as well as offline advertisement data, including, but not limited to, direct mail and/or television total revenue and costs. The data that can be passed along by the internal servers 25 and third party servers 30 can include all types of data that can be utilized by the marketing asset forecasting server 20 to generate marketing forecasts, as discussed below in more detail. In an aspect, the internal servers 25 can be configured to track information through the URL of an advertisement or from a client's pixel tagged website page. Likewise, in an aspect, the third party servers 30 are configured to allow the marketing asset forecasting server 20 to consume client information that was obtained through the advertisers on their third party servers 30. In an exemplary aspect, the internal servers 25 and the third party servers 30 are configured to allow the marketing asset forecasting server 20 to collect actions/events (clicks, transactions, revenue generating occurrences, etc.) that occur on the advertisements. In such aspects, the internal servers 25 and the third party servers 30 can pass along user placed data (i.e., data supplied by a user and not managed or stored within the marketing asset forecasting server 20) to the marketing asset forecasting server 20. The user placed data can be passed along or made available to the marketing asset forecasting server 20 through various known protocols, including, but not limited to, FTP and the like. In an aspect, the marketing asset forecasting server 20, the internal servers 25, and the third party servers 30 can be configured to communicate with multiple network-enabled devices 40 in order to collect data for forecasting.

As shown in FIG. 1, the marketing asset forecasting server 20 may have several applications 206, including a marketing asset forecasting (MAF) application 208, discussed in more detail below. In general, the applications 206 may utilize elements and/or modules of several nodes or servers. In any event, the marketing asset forecasting server 20 should be construed as inclusive of multiple modules, software applications, servers and other components that are separate from the network-enabled devices 40 and third party servers 30.

The marketing asset forecasting server 20 can include system memory 202, which stores the operating system 204 and various software applications 206. The marketing asset forecasting server 20 may also include data 210 that is accessible by the software applications 206. The marketing asset forecasting server 20 may include a mass storage device 212. The mass storage device 212 can be used for storing computer code, computer readable instructions, program modules, various databases 214, and other data for the marketing asset forecasting server 20. The mass storage device 212 can be used to back up or alternatively to run the operating system 204 and/or other software applications 206. The mass storage device 212 may include a hard disk, various magnetic storage devices such as magnetic cassettes or disks, solid state-flash drives, CD-ROM, DVDs or other optical storage, random access memories, and the like.

The marketing asset forecasting server 20 may include a system bus 216 that connects various components of the marketing asset forecasting server 20 to the system memory 202 and to the mass storage device 212, as well as to each other. In an aspect, the mass storage device 212 can be contained within the marketing channel forecasting server 20. In another aspect, the mass storage device 212 can comprise multiple mass storage devices 212 that are found separate from the marketing asset forecasting server 20. However, in such aspects the marketing asset forecasting server 20 can be provided access.

Other components of the marketing asset forecasting server 20 may include one or more processors or processing units (Proc.) 218, a user interface (U.I.) 220, an input/output interface (I/O Int.) 222, and a network adapter (Nwk. Adp.) 224 that is configured to communicate with other devices, including, but not limited to, the internal servers 25, third party servers 30, network-enabled devices 40, and the like. The network adapter 224 can communicate over various networks. In addition, the marketing asset forecasting server 20 may include a display adapter 226 that communicates with a display device 228, such as a computer monitor and other devices that present images and text in various formats. A user can interact with the marketing asset forecasting server 20 through one or more input devices (not shown), which include, but are not limited to, a keyboard, a mouse, a touch-screen, a microphone, a scanner, a joystick, and the like, via the user interface 220.

In an aspect, certain functions and programs performed by the marketing asset forecasting server 20, and discussed in more detail below, can be accessed remotely via the network adapter 224. In an aspect, the marketing asset forecasting server 20 can be configured to allow access to the programs via various known secured methods. For example, verified users of the internal servers 25, the third party servers 30, and the network-enabled devices 40 with the correct login credentials may be able to access the marketing asset forecasting server 20.

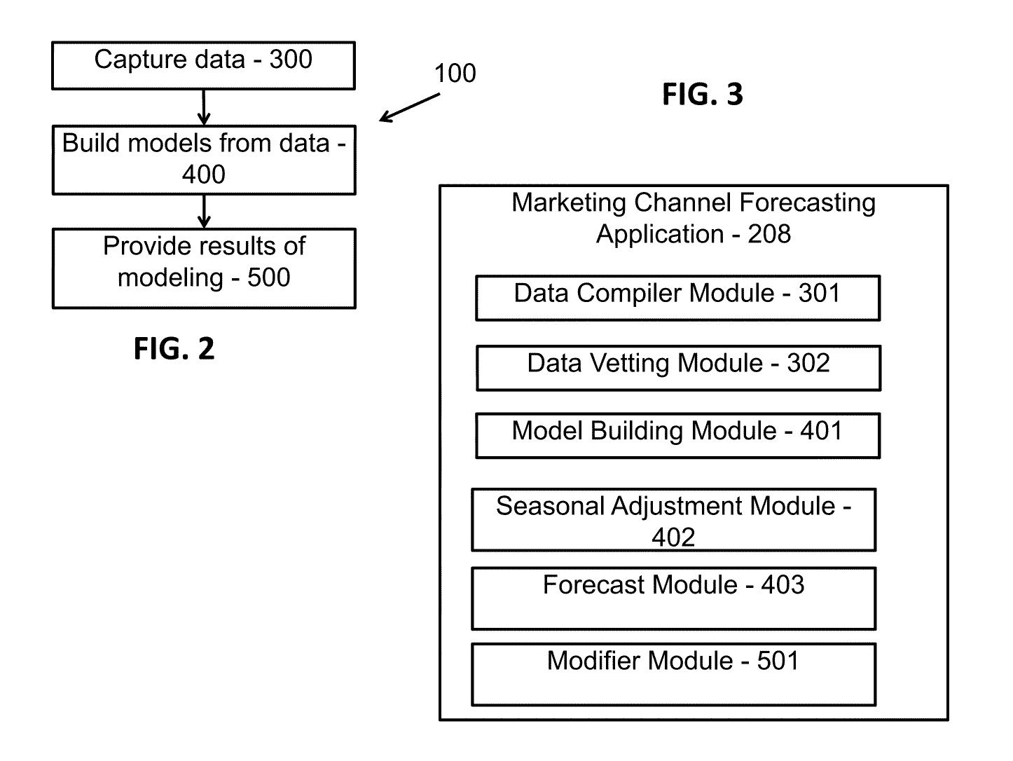

In an aspect, the marketing asset forecasting application 208 is configured to perform a method 100 to create a marketing budget to generate and reach revenue goals for a future timeframe, as shown in FIG. 2. In an aspect, the marketing asset forecasting application 208 can call upon multiple modules, similar to those shown in FIG. 3, to perform the steps of the method 100. In an aspect, the marketing asset forecasting application 208 is configured to capture relevant forecasting data (step 300), build models of forecasts for the marketing asset budgets based upon the captured data (step 400), and provide the results of the modeling to a user (step 500).

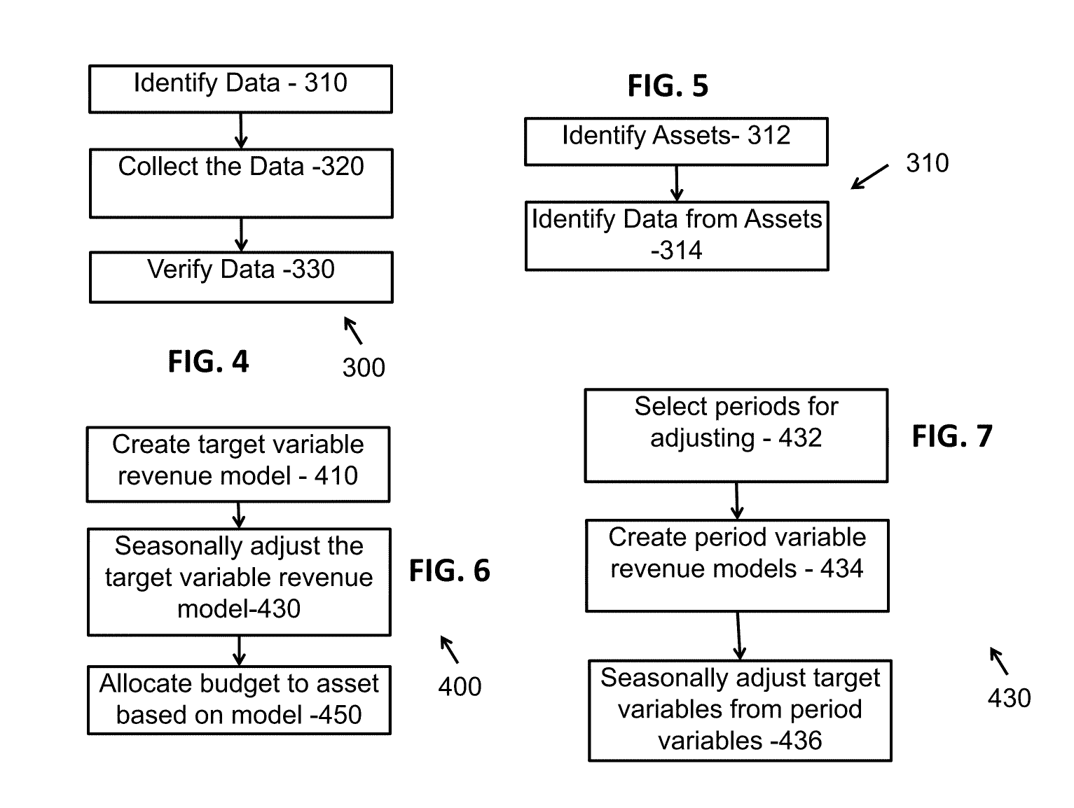

In an aspect, the marketing asset forecasting application 208 is configured to capture relevant forecasting data (step 300). In an exemplary aspect, the process of capturing relevant forecasting data is illustrated in FIG. 4. The process of capturing relevant forecasting data can include identifying the needed data for the forecasting (step 310), collecting the data (step 320), and verifying the data (step 330). In an aspect, the marketing asset forecasting application 208 can call upon a data compiler module 301 and a data vetting module 302 to perform these steps.

In order to collect the data for forecasting, the needed data must be identified (step 310). In an exemplary aspect, identifying the needed data comprises identifying the marketing assets for which the forecasting is desired (step 312), and identifying the data associated with each marketing asset that is needed to develop forecasting models (step 314). In an exemplary aspect, identifying the marketing assets can include identifying the desired marketing channels. In an aspect, the marketing asset forecasting application 208 can call upon the data complier module 301 and data vetting module 302 to perform some or all of these steps.

To begin, the marketing assets need to be identified (step 312). In an aspect, the marketing asset forecasting application 208 can automatically identify the marketing assets/channels/categories for which to forecast based upon the data available to the marketing asset forecasting server 20. In such aspects, the data can be what the marketing asset forecasting server 20 is collecting itself at the request of the user, or the data can be based upon the information sent/supplied by the third party servers 30. In such aspects, the data can be formatted for the marketing asset forecasting application 208. In another aspect, the marketing assets/channels/categories can be identified based upon the selection by a user of the marketing asset forecasting application 208 of a specific business unit (e.g., providing a list of assets/channels/categories desired by the user). For example, a user can select the specific marketing assets, which can include, but not limited to, paid search brand, paid search non-brand, display remarketing, display prospecting, point of sale, organic search, paid social, device type, campaign assets, accounts, landing pages, and the like.

Once the marketing assets have been identified, the data that is needed for each marketing asset is identified (step 314). The data can include the time frame for which the data is to be collected (e.g., the start and stop dates of the past events), the monetary amount of the marketing budget spent on each marketing asset during the said time frame (i.e., spend), the revenue generated by each marketing asset in each time frame. In an exemplary aspect, at least two years of past data is collected in order to ensure accurate analysis. In another aspect, the combination of spend and transactions can be collected instead of revenue. In some instances, the available marketing budget (i.e., the funds available for spending to market the marketing assets presently) can be included in this information. In an aspect, the available marketing budget can be provided for each marketing asset. In an exemplar aspect, the entire available marketing budget can be provided. In such aspects, the marketing asset forecasting application 208 can be configured to determine how to allocate the entire marketing budget to each of the marketing assets to maximize overall revenue, discussed in more detail below. The current overall marketing budget can be supplied by the user upon initiation of the marketing channel forecasting application 208, or at a later time. While the current marketing budget is not necessary for the data collection step, the current marketing budget should be supplied at some point in order to see how the marketing budget should be allocated to each asset in order to maximize revenues.

In addition, some specific marketing assets/channels may also have additional information that is relevant in determining the forecast models. For example, marketing channels can include conversions that correspond to the revenue and spend. In an exemplary aspect, the data selected can be broken down into a more granular level, such that while an overall timeframe for the collection of needed data is done, the revenue and spend can be divided up per time unit of the overall time frame (e.g., spend and revenue by season/quarter/month/week during timeframe).

Once the needed data has been identified (step 310), the data needs can be collected (step 320). In an aspect, the marketing assets selected are not limited to marketing assets managed by the marketing asset forecasting server 20. The marketing assets can be divided into managed assets and unmanaged assets. In such aspects, the data associated with the managed assets can be collected and stored upon the storage device 212 of the marketing asset forecasting server 20 and the data associated with the unmanaged assets can be imported in from another source, including, but not limited to, third party servers 30. Once the data has been collected, the data can be verified and/or vetted (step 330), ensuring that the needed data and categories (e.g., time frame/date, spend, and revenue or conversions) are present and correct.

While FIGS. 4-5 illustrate certain steps occurring in a certain order to collect the data, the present invention is not limited to performing these steps in order described above, nor is the present invention limited to performing all of these steps or just these steps when collecting the data. For example, the data could be collected (step 320) before the data is identified (step 310). Further, all the data could be collected from all of the marketing channels (step 314) before the marketing channels are selected and identified (step 312). Therefore, the collecting of data (step 300) can include a variety of combinations and order of these steps.

After the data is captured (step 300), the marketing asset forecasting application 208 can build the forecasting models from the data (step 400). In an exemplary aspect, the process of building the forecasting models includes creating a target variable revenue model (step 410), seasonally adjusting the resulting target variable revenue model (step 430), and allocating the budget to the asset based on the revenue model (step 450), as illustrated in FIG. 6. In an aspect, the marketing asset forecasting application 208 can call upon a model building module 401 and a seasonal adjustment module 402, illustrated in FIG. 3, to build the models from the data (step 400).

As stated above, the marketing asset forecasting application 208 can call upon the model building module 401 to create the target variable revenue model (step 410). In an exemplary aspect, a target variable revenue model is created for each individual marketing asset for which data has been collected (step 410), providing greater accuracy than if a single target variable revenue model was generated for the combination of all marketing assets. Therefore, the number of target variable revenue models can be based upon the number of marketing assets that are being forecasted. In such aspects, the multiple target variable revenue models can be used in combination to ensure the allocation of the overall budget per asset channel is done in a way to maximize the overall projected revenue of the combined marketing assets.

In an aspect, the models can be generated by using regressional analysis. The models can be generated based upon applying regressional analysis on the data collected (discussed above in step 300). In an exemplary aspect, a least squares regression can be utilized. In an exemplary aspect, an optimized least squares regression can be used by selecting the Beta coefficients that minimize the following least squares residuals equation:

RSS=ρ(yt−yhat)²,

wherein yhat is the estimated regression output for the particular record. By using these coefficients, a nonlinear least squares regression approach can be utilized. In an exemplary example, the following generalized equation can be used:

yi=B0+B1xi/2+B2xî2+ei,

wherein yi is the revenue, xi the spend, and the B being the generated coefficients for each marketing asset. In an exemplary aspect, period specific regression coefficients are generated to perform the seasonal adjustment, which are utilized in the seasonal adjustment step (430). The coefficients can be generated for periods (quarter/month/week/day) desired by the user, discussed in detail below. In an aspect, the periods can be selected before generating the target variable revenue model.

While the exemplary aspects above utilize a nonlinear least squares regression and least square regression to form the target variable revenue models, other forms of regression can be utilized, including, but not limited to, locally weighted regression (LOESS), non-parametric regression, Spline regression, polynomial regression, and the like. In an aspect, single models are formed for each marketing asset. In an aspect, the marketing asset forecasting application 208, via the model building module 401, is not limited to using regression analysis to build the models (step 410). For example, the model building model can build the target revenue models utilizing support vector machines, neural networks, non-linear extrapolation, regression trees, non-parametric regression, bayesian methods, SWARM methods, piecewise regression, random forests, and other statistical learning methods.

Once a target variable revenue model has been generated, and in the exemplary aspect one model for each marketing asset, the marketing asset forecasting application 208 can then optimize the model(s) utilizing a seasonal adjustment (step 430). In an aspect, the marketing channel forecasting application 208 can call upon the seasonal adjustment module 402 to assist. In an aspect, the seasonal adjustment module 402 can optimize the target variable revenue model(s) utilizing a seasonal adjustment by selecting the periods for seasonal adjustment (step 432) (as created as a result of the method of 410), creating period variable revenue models for the periods (434), and then adjusting the full term variable target model(s) based upon the period variable target models (436), as shown in FIG. 7.

In an aspect, the periods for the seasonal adjustment can be selected based upon the needs of model(s) (step 432). In an aspect, the periods can be as sensitive as the data allows and the user selects. The seasonal adjustment is based upon the periods (quarter/month/week/day) desired by the user. In some aspects, a user can select the timeframe from which the data is selected. This allows a user to make more informed decisions for the variable target model. For example, a user may know that a specific time period from 2 years ago was unnecessary influenced by unexpected events that do not occur on a seasonal basis that would unjustly influence the adjustment (e.g., inclement weather), and therefore only form the variable target model(s) for the timeframe from just after that period to the present. In an aspect, the selection of the timeframe can be done at the selection of the data (step 300), before the generation of the full term target variable model(s) (step 410), or the seasonal adjustment (step 430).

Once the periods have been selected, the period variable revenue models for the periods selected can be created (step 434). Period variable revenue models are generated for each period of the timeframe of the target variable revenue model. In an exemplary aspect, period variable revenue models are made for each marketing asset, similar to the target variable revenue models discussed in step 410. In an aspect, the period variable revenue models can be generated through regressional analysis. The types of regressional analysis employed can include the same types of regressions discussed above in relation to the full term variables revenue models.

In an exemplary aspect, a holdout method of estimation is performed for each time period (434) to estimate the seasonality for the time period. The holdout estimate for each time period is made by regressing all of the data corresponding to the entire asset except that which is in the time period being estimated for that particular marketing asset. For example, if the timeframe was a calendar year with time periods being months, the holdout regression for each month (e.g., the month of January) would utilize all of the data except for the given month (i.e., the data for the month of January is not used), showing how holding out a particular month can have an effect upon the overall data. In this example, the holdout regression is done for every month, thus 12 new objects are created per marketing asset. In an aspect, period specific regression coefficients are generated to perform the seasonal adjustment. In an aspect, an algorithmic time based holdout method of estimation can be utilized to generate the period specific regression coefficients of the period variable revenue models. In an aspect, the same types of regressions discussed above with altered coefficients can be utilized to form the holdout estimates.

Once the period variable revenue models are created for each time period, the period variable revenue model(s) can be utilized to seasonally adjust the target period variable revenue models (436). In an aspect, when regression analysis has been utilized to create coefficients for the period variable revenue models and the target variable revenue models, the corresponding coefficients can be compared against one another to form the predictive target variable revenue model (436). In an exemplary aspect, a ratio can be created based upon the comparison for the corresponding future time period in the new model. For example, if the beta (coefficient) for the target variable revenue model (i.e., the model based upon the data from the full timeframe) of the overall asset is found to be 100, and the beta (coefficient) for the corresponding period variable revenue model is 60, the beta (coefficient) for the portion of the time period represented in the target variable revenue model for the future can be adjusted by a factor of 60/100 or 0.6. This means that the seasonality of this time period being withheld from the data changes the time period's beta by a factor of 60%. Taking this change into account, the beta is adjusted so subsequent point estimates for this period of the timeframe can be formed (e.g., the January coefficient would be adjusted to 60% of its original value).

After the target variable revenue model(s) for each marketing asset has been seasonally adjusted (step 430), the marketing asset forecasting application 208 can then allocate the marketing budget to each asset based upon the target variable revenue model (step 450). In an aspect, the marketing asset forecasting application 208 can call upon the forecast module 403 to perform the action of allocation of the marketing budget. In an aspect, the allocation is done in order to maximize the revenue generated based upon the target variable revenue models expected return for that marketing asset. In other words, by allocating what portion of the budget (spend) to the marketing asset at a given time (period) will generate the most revenue over the whole entire time period of the future target variable revenue model. In an exemplary aspect, the allocation of the marketing budget for each marketing asset is based upon the steepness of the slopes of the target variable revenue models. In an aspect, the slope is based upon the coefficients, where the higher the coefficients, the larger the steepness.

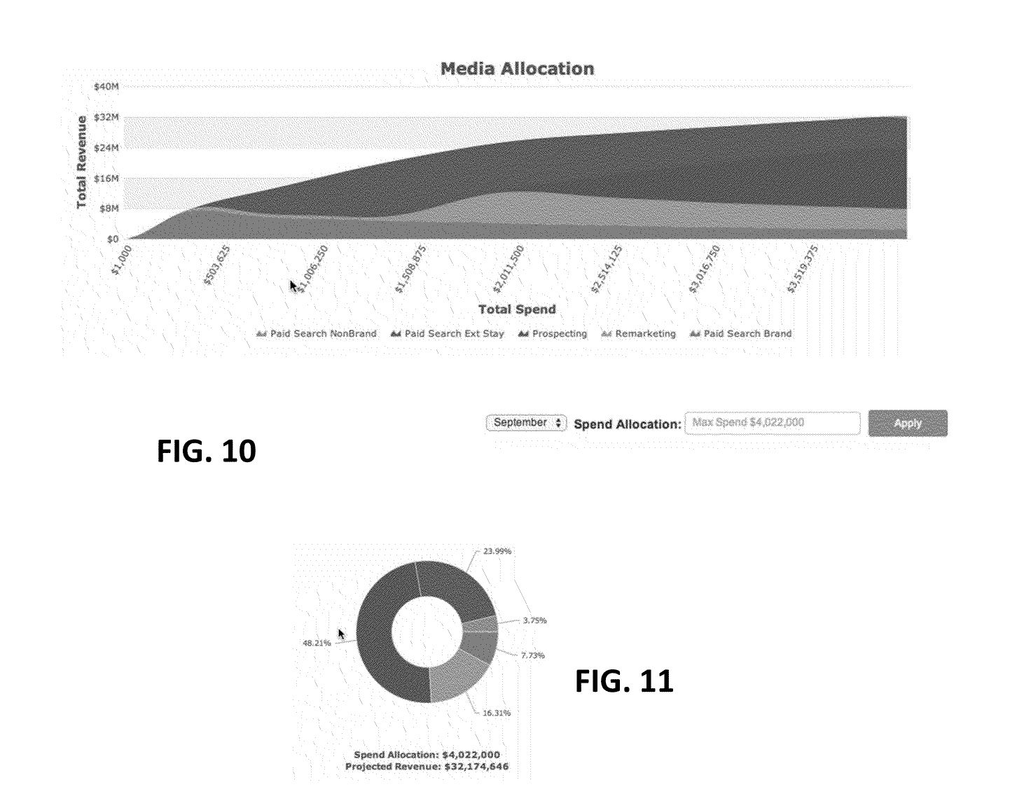

In an exemplary aspect, the marketing asset forecasting application 208, via the forecast module 403, can allocate the overall general budget for each marketing asset based upon the combination of the target variables revenue models for each marketing aspect. In such aspects, the slopes of the assets of the target variable revenue models can be compared pairwise in order to determine the allocation of spend for each channel at the given time period. In an aspect, the pairwise comparison of the slopes of the target variable revenue models enables the marketing asset forecasting application 208 to stack curves representative of the target variable revenue models on top of one another in a single chart, as shown in FIG. 10. In an aspect, a sorting algorithm can be utilized to allocate an allotted amount of spend out of the given overall budget to one of the marketing assets based upon the curve results. The sorting algorithm can be configured to sort the allocated spend by the expected amount of revenue from that spend for a particular asset based upon the generated revenue estimates from the target variable revenue models. In an exemplary aspect, the sorting algorithm can be configured to sort the spend based upon the vector of the revenue for a marketing asset from the target variable revenue model, since the revenue vector contains all of the elements of revenue for the client.

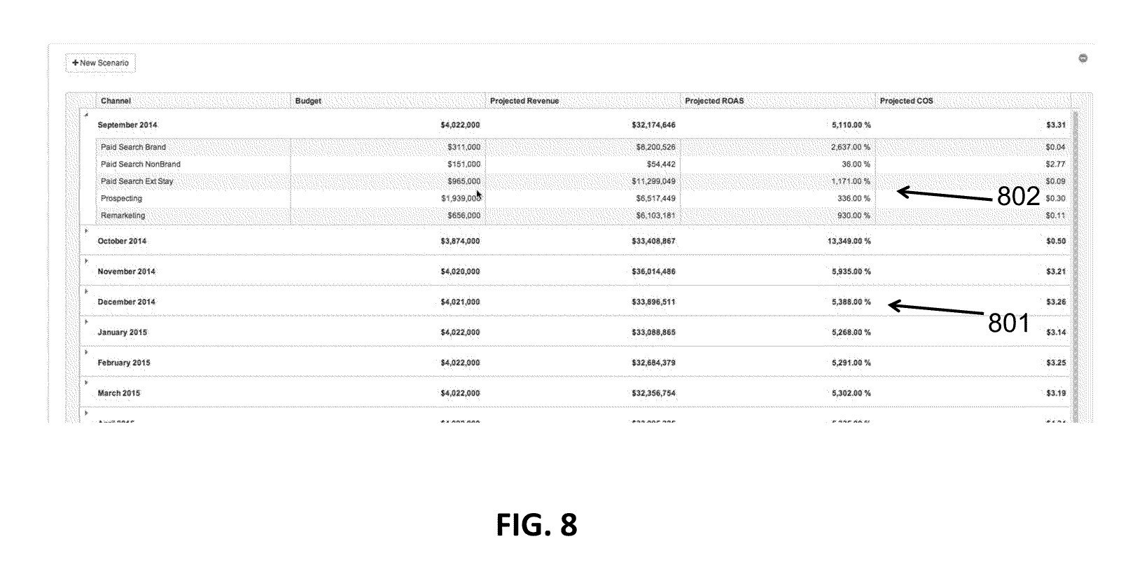

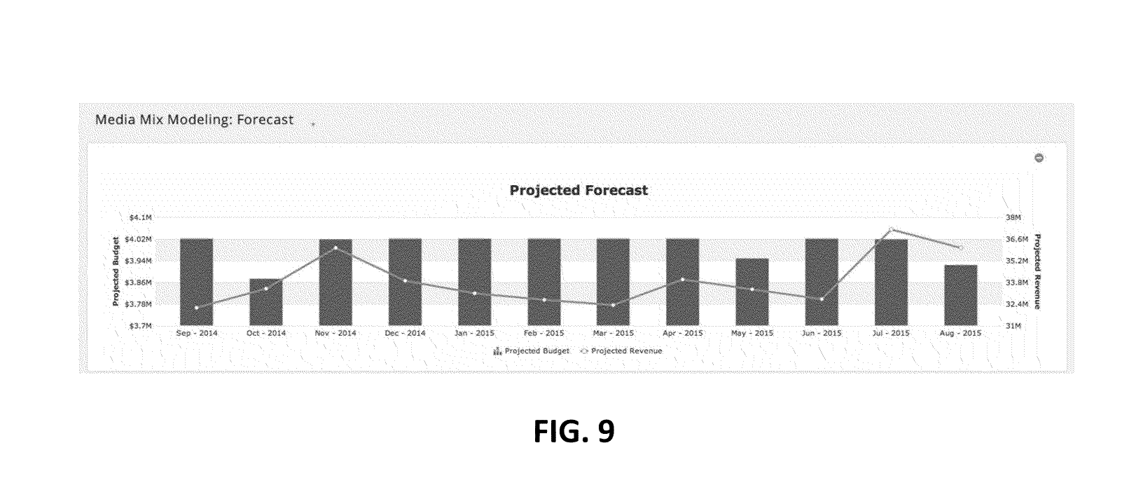

Once the allocation has been completed (step 450), the results of the modeling can be presented (step 500). The results of the modeling can be presented to the user via the display device 228 in a number of ways. In an aspect, the results can be formed into different objects. For example, the application 208 can create objects that contain all of the estimated data to fill out a gird provided to a user, as shown in FIGS. 9a-b, or in a forecast view as shown in FIG. 10. As shown in FIGS. 8, the results from the target variable models can be displayed as the planned budget and projected revenue over the projected timeframe. The results can be broken down by the totals for spend over all channels in a given month to produce a given revenue and ROA (see 801) or per channel (see 802). FIG. 9 illustrates a forecast view of all of the marketing assets generated by the target variable revenue models.

In another aspect, the objects can be presented in a manner that reflects the entire revenue and spend dimensions in one visual, as shown in FIG. 10. The visual displays the media mix with revenue on the X axis, spend on the Y axis, and proportional spend to revenue per month making up the colored portion of the chart. Further, a user can then see the proportion of spending per marketing channel, as shown in FIG. 11.

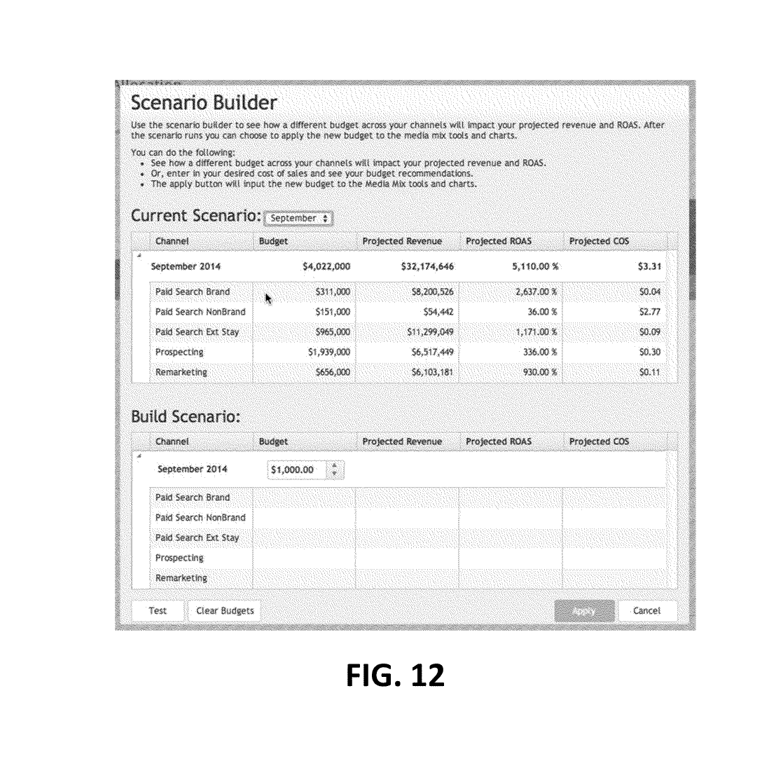

In another aspect, the application 208 is configured to allow a user to make changes to the estimated spend amount for a particular month or months for one or multiple marketing channels. For example, if a user wants to alter some the spend amount for a given time period, the marketing channel forecasting application can call upon the modifier module 501. In an aspect, the modifier module 501 can create a user interface similar to that shown in FIG. 12 for which the user can interact. By doing so, the user enters an amount of spend in order to see estimates of revenue at the new level. In an aspect, the modifier module 501 can utilize the target revenue variable models that have been seasonally adjusted to generate the new projected revenue based upon the supplied amount of spend. In an aspect, the modifier module 501 can be configured to allow the user to supply the spend across the entire projected period for all of the channel assets, supply the spend across individual channel assets for the entire period, across all the channel assets for specified periods, across a selected channel asset for a specified period(s), and/or various other combinations.

In an aspect, the modifier module 501 can be configured to have decisions boundaries for the selection of the user. For example, the modifier module 501 can be configured such that if a maximum spend budget is applied for all of the marketing assets, the modifier module 501 would not allow the user to select a budget for a particular asset to go over the provided maximum spend budget. Other similar decision boundaries can be provided and enforced by the modifier module 501, including, but not limited to, the sum of the budgets provided/selected by the user for each asset channel cannot be over the maximum spend budget, limits on the amount of spend budget per month, etc.

In another aspect, the modifier module 501 can have decision boundaries determined by the estimates of revenue and spend generated by the target variable revenue models. For example, the target variable revenue model can generate an estimate for spend for a specific marketing asset for a specific time period (e.g., social media for the month of July). The modifier module 501 can be configured to be bound by this estimate (i.e., the user cannot spend more than the estimated spend) for the marketing asset for the specific time period.

In an aspect, other views can be provided to the user. For example, a marketing asset efficiency view can be provided. The marketing asset efficiency view compares assets across each other for a particular period of time. A seasonality view can be provided with shows a comparison across time for a particular marketing channel to show the impact of the seasonality on it. These views can be generated across target variable revenue models discussed above, providing a user with a different visual interpretation of the data.

Once the user has tested the new spend amount across one or all marketing assets, the user can elect to apply the new estimates to the overall model, calling on the other modules to carry out the build models from data (step 400) and providing the results (Step 500) again. In an exemplary aspect, the new and old data is sent from the user interface back through a python API to a waiting R script. The R scripts accepts the inputs and re-runs the model using the overall spend amount and the individual channel spend amount as a lookup value to the initial data object that holds the estimated revenue for the particular month. Once the lookup value has found a match, the scenario builder code sends the match to the grid method, the chart methods, and the forecast method and re-initializes the user interface. The applied user input is saved to a new image of the overall model which allows the user the ability to close out of the application altogether yet not lose the changes.

In an aspect, the marketing asset forecasting system 10 discussed above provides marketers with the know-how on how and where to spend their money in the most efficient ways. Having an understanding of a previous budget and revenue helps marketers adequately meet their marketing goals without over or under cutting revenue. This allows marketers to more accurately make a case for budgets and present to CMOs more accurate and achievable goals based on those budgets or constraints.

Having thus described exemplary embodiments of the present invention, those skilled in the art will appreciate that the within disclosures are exemplary only and that various other alternatives, adaptations, and modifications may be made within the scope of the present invention. Accordingly, the present invention is not limited to the specific embodiments as illustrated herein, but is only limited by the following claims.

What is claimed is:

1. A marketing asset forecasting system comprising:
a. a marketing asset forecasting server comprising:
i. a processor;
ii. memory; and
iii. a marketing asset forecasting application configured to:
A. collect forecasting data for marketing assets;
B. build at least one target variable revenue models for the marketing assets;
C. adjust seasonally the at least one target variable revenue model; and
D. allocate marketing budgets to the marketing assets based upon the at least one seasonally adjusted target variable revenue model.

2. The marketing asset forecasting system of claim 1, wherein the marketing asset forecasting application comprises a data compiler module configured to collect the forecasting data for marketing assets by:
a. identifying needed marketing assets;
b. identifying the forecasting data associated with the identified marketing assets; and
c. capturing the identified forecasting data.

3. The marketing asset forecasting system of claim 2, wherein the marketing asset forecasting application further comprises a data vetting module configured to vet the captured identified forecasting data.

4. The marketing asset forecasting system of claim 2, wherein the forecasting data includes spend and revenue from the identified marketing assets for past periods.

5. The marketing asset forecasting system of claim 4, wherein the forecasting data further comprises future marketing asset budgets.

6. The marketing asset forecasting system of claim 1, wherein the marketing assets comprise marketing channels.

7. The marketing asset forecasting system of claim 1, wherein the marketing asset forecasting application comprises a model building module to build the at least one target variable revenue model by utilizing regressional analysis on the collected forecasting data for the marketing assets.

8. The marketing asset forecasting system of claim 7, wherein the model building model utilizes least squares regression to build the at least one target variable revenue model.

9. The marketing asset forecasting system of claim 8, wherein the model building model selects beta coefficients that minimize the least squares regression.

10. The marketing asset forecasting system of claim 7, wherein the model building module is further configured to build individual target variable revenue models for each marketing asset and combine the results into the at least one target variable revenue model.

11. The marketing asset forecasting system of claim 1, wherein the marketing asset forecasting application comprises a seasonal adjustment module to adjust seasonally the at least one target variable revenue model, wherein the seasonal adjustment module is configured to:
a. select periods for seasonal adjustment;
b. create period variable revenue models for the selected periods; and
c. adjust the at least one variable target revenue model based upon the period variable target revenue models.

12. The marketing asset forecasting system of claim 11, wherein the seasonal adjustment module is configured to create the period variable revenue models for the selected periods using regressional analysis.

13. The marketing asset forecasting system of claim 12, wherein the seasonal adjustment module further uses a holdout method for each period variable revenue model.

14. The marketing asset forecasting system of claim 11, wherein the seasonal adjustment module creates the period variable revenue models by creating individual period variable revenue model for each marketing asset.

15. The marketing asset forecasting system of claim 1, wherein the marketing asset forecasting application comprises a forecasting module for allocating the marketing budgets to the marketing assets based upon the at least one seasonally adjusted target revenue model.

16. The marketing asset forecasting system of claim 1, further comprising a modifier module configured to modify the marketing budgets for the marketing assets after the allocation of marketing budgets.

17. The marketing asset forecasting system of claim 1, further comprising at least one internal server, wherein the marketing asset forecasting server is configured to collect the forecasting data from the at least one internal server, at least one third party server, or at least one network-enabled device.

18. A method for allocating marketing budgets to marketing assets, comprising the steps of:
a. collecting forecasting data for the marketing assets, wherein the forecasting data comprises revenue and spend for the marketing assets;
b. building at least one target variable revenue models for the marketing assets using regressional analysis of the collected forecasting data;
c. adjusting seasonally the at least one target variable revenue model by building period variable revenue models for selected periods and adjusting the at least one target variable revenue model with the period variable revenue models; and
d. allocating marketing budgets to the marketing assets based upon the at least one seasonally adjusted target variable revenue model.

19. The method of claim 18, wherein building the at least one target variable revenue model comprises building a target variable revenue model for each of the marketing assets, and wherein adjusting seasonally the at least one target variable revenue model further comprises building individual period variable revenue models for each of the marketing assets.

20. A marketing asset forecasting system comprising:
a. at least one internal server;
b. a marketing asset forecasting server configured to communicate with the at least one internal server and at least one third party server and at least one network-enabled device, wherein the at least one internal server, third party server, and network-enabled device collect forecasting data, the marketing asset forecasting server comprising:
i. a data compiler module configured to:
A. identify needed marketing assets;
B. identify the forecasting data associated with the identified marketing assets; and
C. capture the identified forecasting data from the at least one internal server and the at least one third party server and the at least one network-enabled device;
ii. a data vetting module configured to vet the captured identified forecasting data;
iii. a model building module for building models of forecasts for the selected marketing assets from the captured identified forecasting data, the model building module configured to:
A. create a target variable revenue model by creating a target variable revenue model for each marketing asset through the use of least squares regressional analysis; and
B. combining each target variable revenue model for each marketing asset into a full term variable target model;
iv. a seasonal adjustment module to seasonally adjust the full term variable target model, the seasonal adjustment module configured to:
A. select a period for seasonal adjustment;
B. create period variable revenue models for the periods, wherein creating the period variable revenue models further comprises making a period variable revenue model for each marketing asset using regressional analysis using a holdout method for each time period; and
C. adjust the full term variable target model based upon the period variable target models;
v. a forecast module for allocating the marketing budget to the marketing assets based upon the revenue model; and
vi. a modifier module configured to allow adjustments to the allocation of the marketing budgets.
